(19) United States
(12) Patent Application Publication
(10) Pub. No.: US 2004/0240866 A1
(43) Pub. Date: Dec. 2, 2004

(54) Image capture and display system

(76) Inventor: Andrew Paul Ramsbottom, Benfleet (GB)

Correspondence Address: SMITH, GAMBRELL & RUSSELL, LLP, 1850 M STREET, N.W., SUITE 800, WASHINGTON, DC, 20036, US

(21) Appl. No.: 10/493,872

(22) PCT Filed: Feb. 18, 2003
(86) PCT No.: PCT/GB03/00710

(30) Foreign Application Priority Data
Feb. 21, 2002 (GB) 0204094.7

(51) Int. Cl. G03B 29/00

(52) U.S. Cl. 396/17

(57) ABSTRACT

An apparatus and method for capturing and displaying images, using a system which synchronously controls a scanning image capture means and a scanning display means, is described with reference to an optical instrument such as a borescope or endoscope. The apparatus (10) comprises a scanning image capture means (32) receiving light from an object and producing an output representative thereof. Amplification means (46) amplifies the output and drives a light source (48) which provides light for a scanning image display system (52) which is operable to create a image of the object. Control means (56) is operable to synchronise operation of the scanning image capture means (32) and the scanning image display means (52). In this way, the invention provides a reel time high resolution image capture and display system.

The present invention relates to an apparatus and method for capturing and displaying images using a scanning system, in particular a system which synchronously controls a scanning image capture means and a scanning display means. A practical application is described with reference to an optical instrument such as a borescope or endoscope.

In conventional optical instruments such as borescopes, an image may be transmitted via a train of lenses either directly to an observer's eye or to a camera mounted on the eyepiece of the instrument for display on a screen. Alternatively, an image-to-video conversion device such as a CCD may be incorporated in the distal end of the instrument for receiving the image directly for transmission to a screen for display. A disadvantage of such conventional systems is the fact that the objects to be viewed must be well illuminated and therefore additional means for providing this illumination is necessary. Display means such as a monitor or LCD screen is also needed if a camera or CCD is employed to capture the images.

The present invention provides apparatus for obtaining and displaying an image of an object, comprising scanning image capture means operable to receive light from the object and to produce an output representative thereof, amplification means to amplify the output, a light source driven by the amplified output and operable to provide light for a scanning image display system operable to create an image of the object, and control means operable to synchronise operation of the scanning image capture means and the scanning image display means.

Thus, the invention provides a real time, high resolution image capture and display system.

Preferably, the apparatus further comprises means to illuminate the object.

The illumination means may comprise at least one LED or laser diode.

The scanning image capture means preferably includes means to scan the direction of view over the object and detector means to receive light from the object and convert it to the output.

The means to scan the direction of view may include at least one reflector mounted for rotation about two mutually perpendicular axes.

Conveniently, the or each reflector is arranged to receive light from the illumination means and to scan it across the object in order to provide illumination.

The illumination means may provide separate beams of red, green and blue light and further comprise means to combine the separate beams.

Preferably, the scanning image display means includes at least one reflector mounted for rotation about two mutually perpendicular axes and a light source arranged to provide light to the or each reflector.

The light source of the scanning image display means may comprise at least one LED or laser diode.

The light source may provide separate beams of red, green and blue light and further comprises means to combine the separate beams.

In a preferred embodiment, the scanning image display means is operable to scan directly onto the retina of an observer's eye.

In this case, the scanning image display means may further comprise focussing means.

The invention also provides a borescope including an apparatus for obtaining and displaying an image as described above.

The borescope preferably includes at least one optical fibre to transmit light to illuminate the object.

The borescope preferably also includes at least one optical fibre to transmit light received from the object to the detector means.

The invention also provides a method of obtaining and displaying an image of an object, comprising the steps of detecting light from an object with a scanning image capture means to produce an output representative of the light detected, amplifying the output, employing the amplified output to drive a scanning image display means to create an image of the object, and synchronously controlling the scanning image capture means and the scanning image display means.

The invention will now be described in detail by way of example only, with reference to the accompanying drawings in which:

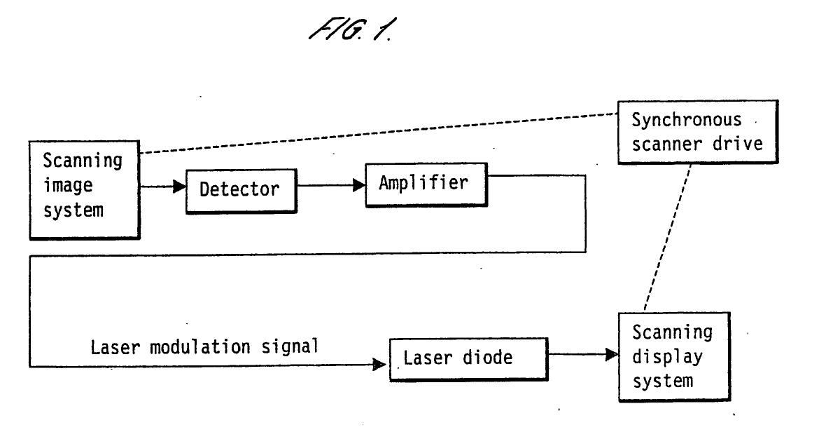

FIG. 1 is a block diagram illustrating an image capture and display system in accordance with the present invention;

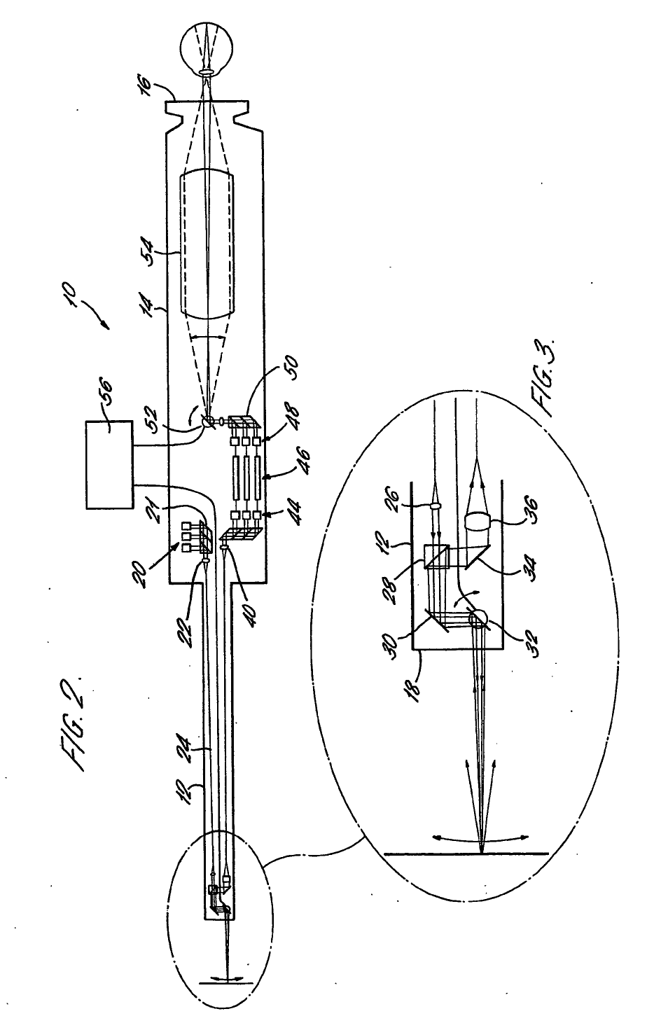

FIG. 2 is a schematic diagram of a borescope incorporating an embodiment of the invention; and

FIG. 3 is an enlarged view of the distal end of the borescope of FIG. 2.

Image capture by means of raster scanning onto a single detector is a known technique. The technique can operate in a number of ways. For example, in viewing a scene that is pre-illuminated a simple optical system may form an image of the object scene on a tiny pinhole in front of a detector. The pinhole effectively serves to select or resolve a small, defined area of the scene. A scanning system then serves to scan the direction of view such that adjacent pixels are sequentially captured as a signal from the detector. These signals can be stored for later use or processed appropriately to produce a standard video signal. Alternatively, if the object requires illumination, then this can be provided by scanning a tightly focussed laser beam across the object, the laser spot itself now also providing the spatial resolution instead of a pinhole.

Another known concept is that of a scanned display, for displaying an image, for example, from a video output signal. The input video signal is processed and used to modulate the intensity of a laser beam as it is raster scanned to produce an image on a screen. This is analogous to a conventional cathode ray tube where an electron beam is similarly scanned and modulated across a phosphor screen to display an image.

The general layout of a system in accordance with the invention which combines these principles is shown schematically in FIG. 1. A scanning system is used to capture images of an object scene by scanning light across a single detector. The detected signal is amplified and used directly to provide a modulation signal for an appropriate light source, such as a laser diode or LED, of a scanning display system.

The scanning display system may provide an image on a monitor or LCD display. Alternatively, a retinal scanning display system may be employed, obviating the need for a separate monitor or screen. In this case, instead of scanning a laser beam onto a screen the modulated beam can be scanned directly onto the retina of the eye, so as to give the sensation of observing an image. The advantage of retinal scanning is the ability to present a large, bright, high resolution image in a relatively simple optical system with very low power illumination requirements.

The key to this system is driving the scanning image system synchronously with the scanning display system. Signals from the detectors of the image scanning system are amplified and provide the modulation signal for the lasers or LEDs of the scanning display.

The system may provide a monochromatic image if that is sufficient, although full colour imaging is also possible. To achieve this, one option is to employ three separate beams of light in the primary colours red, green and blue. These can be combined for scanning across the object. Reflected light from the object is passed through appropriate filters to separate detectors to detect the primary colour components of the scanned object. Outputs from the three detectors can be used to modulate three light sources producing red, green and blue beams which can again be combined for use in the scanning image display system.

One practical application of a system in accordance with the invention in FIG. 1 is a borescope as shown in FIGS. 2 and 3. The borescope 10 comprises an elongated insertion tube 12 which can be inserted, for example, into a piece of machinery to be inspected such as a gas turbine engine. A housing 14 is mounted at the proximal end of the insertion tube 12. The housing includes an eyepiece 16 for the observer to look through. The distal end of the insertion tube 12 includes a viewing window 18 which in this example is shown for forward viewing, although lateral viewing is also possible.

A light source 20 is provided in the housing 14, typically in the form of LEDs or laser diodes creating three beams of light in red, green and blue, to provide a colour imaging system. The beams are combined by a spectrally selective mirror and filter assembly 21 and focussed by a first lens 22 on to the end of an optical fibre 24 for transmission to the distal end of the insertion tube 12.

The distal end of the insertion tube 12 is best seen in FIG. 3. As shown, light from the optical fibre 24 passes through a lens 26 and a beam splitter device 28 to a first reflector 30 which diverts the beam towards a scanning reflector 32 which is mounted for rotation about two mutually perpendicular axes. The first axis is perpendicular to the plane of the figure and allows rotation in the direction of the arrows shown. The second axis is parallel to the plane of the figure.

The scanning reflector 32 directs the light out of the viewing window 18 towards the object scene and is rotated as appropriate about its two axes to scan the beam across the scene. Some of the light scattered from the object scene returns into the borescope 10 through viewing window 18 and is directed by the scanning reflector 32 and the first reflector 30 back to the beam splitter 28. This diverts the returned light to a second reflector 34 which passes it through a second, focussing lens 36 and into an optical fibre 38 for transmission back to the housing 14.

Referring back to FIG. 2, the returned light beam passes through a third lens 40 and spectrally selective filter and mirror assembly 42 which splits the beam back into its red, green and blue components which are detected by detectors 44. The detected signals are amplified by amplifiers 46 and used to operate light sources 48, again in the form of LEDs or laser diodes, to produce red, green and blue beams for the scanning display system. The scanning display beams are passed via a spectrally selective mirror and filter assembly 50 to combine them, to a scanning reflector 52 which is also mounted for rotation about two mutually perpendicular axes. The scanning reflector 52 is operated to scan the display beam, via a lens system 54 for focussing purposes, directly onto the retina of an observer's eye.

The scanning reflectors 32 and 52 for image capture and display respectively are controlled synchronously by control means 56. This ensures that the observer has the sensation of seeing an image which is large, bright, in colour and in high resolution as well as being in real time. No external illumination of the object scene is required and only comparatively simple electronic processing is needed.

The system is also capable of providing a zoom function without loss of pixel resolution. This can be achieved simply by changing the scanning amplitude of the reflector 32 at the distal end of the device.

The skilled reader will appreciate that a number of modifications and variations can be made to the system described without departing from the scope of the claims. For example, more than one rotatable reflector can be used in the scanning image capture system and the scanning image display system. The need for one or both optical fibres can be avoided if the illumination light source and/or the detectors amplifiers and display light source are provided at the distal end of the scope rather than in the housing at the proximal end. Although the embodiment illustrated has a single eyepiece, the system could be adapted to provide two eyepieces for stereo vision. Although a retinal scanning system is described as the preferred embodiment since this provides a self-contained system, the borescope could also be adapted for attachment to a camera or to incorporate a CCD for conventional image display on a screen.

1. Apparatus for obtaining and displaying an image of an object, comprising scanning image capture means operable to receive light from the object and to produce an output representative thereof, amplification means to amplify the output, a light source driven by the amplified output and operable to provide light for a scanning image display system operable to create an image of the object, and control means operable to synchronise operation of the scanning image capture means and the scanning image display means.

2. Apparatus as claimed in claim 1, further comprising means to illuminate the object.

3. Apparatus as claimed in claim 2, wherein the illumination means comprises at least one LED or laser diode.

4. Apparatus as claimed in claim 2, wherein the scanning image capture means includes means to scan the direction of view over the object and detector means to receive light from the object and convert it to the output.

5. Apparatus as claimed in claim 4, wherein the means to scan the direction of view includes at least one reflector mounted for rotation about two mutually perpendicular axes.

6. Apparatus as claimed in claim 5, wherein the or each reflector is arranged to receive light from the illumination means and to scan it across the object in order to provide illumination.

7. Apparatus as claimed in claim 2, wherein the illumination means provides separate beams of red, green and blue light and further comprises means to combine the separate beams.

8. Apparatus as claimed in claim 1, wherein the scanning image display means includes at least one reflector mounted for rotation about two mutually perpendicular axes and a light source arranged to provide light to the or each reflector.

9. Apparatus as claimed in claim 8, wherein the light source of the scanning image display means comprises at least one LED or laser diode.

10. Apparatus as claimed in claim 9, wherein the light source provides separate beams of red, green and blue light and further comprising means to combine the separate beams.

11. Apparatus as claimed in claim 1, wherein the scanning image display means is operable to scan directly onto the retina of an observer's eye.

12. Apparatus as claimed in claim 11, wherein the scanning image display means further comprises focussing means.

13. A borescope including an apparatus for obtaining and displaying an image as claimed in claim 1.

14. A borescope as claimed in claim 13, including at least one optical fibre to transmit light to illuminate the object.

15. A borescope as claimed in claim 13, including at least one optical fibre to transmit light received from the object to the detector means.

16. A method of obtaining and displaying an image of an object, comprising the steps of detecting light from an object with a scanning image capture means to produce an output representative of the light detected, amplifying the output, employing the amplified output to drive a scanning image display means to create an image of the object and synchronously controlling the scanning image capture means and the scanning image display means.
